(19) United States
(12) Patent Application Publication
(10) Pub. No.: US 2012/0268500 A1
(43) Pub. Date: Oct. 25, 2012

(54) METHOD FOR ACCELERATING SPEED OF REFRESHING IMAGE FRAME OF DISPLAY-PANEL AND DISPLAY DEVICE FOR RAPID REFRESHING IMAGE FRAME

(75) Inventors: Yao-Tsung Chang, New Taipei City (TW); Chun-Lung Cheng, New Taipei City (TW)

(73) Assignee: WISTRON CORP., New Taipei City (TW)

(21) Appl. No.: 13/186,659

(22) Filed: Jul. 20, 2011

(30) Foreign Application Priority Data
Apr. 20, 2011 (TW) 100113774

(51) Int. Cl. G09G 5/10

(52) U.S. Cl. 345/690

(57) ABSTRACT

A method for accelerating speed of refreshing image frame is used for driving a display-panel to display and refresh an image frame rapidly. According to the method, the first step is to extract a digital content and generate the image frame according to the digital content, so as to drive the display-panel to display the image frame. A partial refresh area is defined on the image frame, and a partial image frame rather than the entire image frame is refreshed, so as to accelerate the speed of refreshing the image frame. Optionally, a number of gray levels of the partial refresh area are reduced, so as to accelerate the speed of refreshing the image frame. At least one screen operation command is received, partial refresh content is extracted from the digital content according to the screen operation command, and a displayed content in the partial refresh area is refreshed.

### CROSS-REFERENCES TO RELATED APPLICATIONS

This non-provisional application claims priority under 35 U.S.C. §119(a) on Patent Application No. 100113774 filed in Taiwan, R.O.C. on 2011/4/20, the entire contents of which are hereby incorporated by reference.

### BACKGROUND OF THE INVENTION

1. Technical Field

This disclosure relates to the image frame refresh of a display-panel, and more particularly to a method for accelerating speed of refreshing image frame and display device for rapid refreshing image frame.

2. Related Art

The advantages of electrophoretic display-panel (electronic paper) devices, such as electronic books (E-Books), and electronic readers (E-Readers), are in reading like printed paper and saving power, and are thus suitable for long-time reading. When the electrophoretic display-panel is powered off as the power supply is cut off, the last image frame displayed can still be remained on the screen, and does not disappear due to the lack of power.

In an image frame refresh process of the electrophoretic display-panel (electronic paper), control electrodes are first used to clear the display of each pixel of the image frame to blank, and then new image data is used to refresh the color level (or gray level) of each pixel one by one. A rather long time is required for each pixel to transit from blank to a desired color level. The electrophoretic display-panel is not therefore applicable to dynamic image display, but is suitable for applications such as E-Books, where the image frame is refreshed one page at a time.

When the user continuously inputs screen operation commands such as scrolling the image frame upwards or downwards by one line of text, the entire image frame has to be refreshed continuously, even if each screen operation command only scrolls the image frame upwards or downwards by only a single line. The continuous input of screen operation commands means that the final image frame cannot be obtained until the entire image frame is refreshed multiple times.

When the user rapidly inputs screen operation commands, the image frame refreshing speed is lower than the input speed of screen operation commands by the user. In this case, the user always feels that electrophoretic display devices such as E-Books have a slow response, affecting user-machine interaction. Even worse, if the user continuously repeats the switch operation, the user is not able to confirm whether the number of inputs is correct due to the low refresh speed, and as a result the user may even continuously input screen operation commands due to the slow image frame refresh speed, causing operation difficulties.

Furthermore, the application of the electrophoretic display-panel is also limited due to the low image frame refresh speed. Current applications only involve static text reading and a small part of static image content viewing. Problems exist even for static image contents, for example, the image frame refresh is rather slow after the image is zoomed in or out. The operation for panning image frame encounters the same problem. These problems are the reasons why some electrophoretic display devices completely abandon operation functions other than page up and page down operations.

### SUMMARY

In one or more embodiment of this disclosure, a method for accelerating speed of refreshing image frame is used for driving a display-panel to display an image frame and refreshing the image frame rapidly.

According to the method, the first step is to generate the image frame according to the digital content, so as to drive the display-panel to display the image frame; and then it is to define a partial refresh area on the image. Finally, after receiving at least one screen operation command, the step is to extract partial refresh content from the digital content according to the screen operation command, and to refresh displayed content in the partial refresh area according to the partial refresh content.

One or more embodiment of this disclosure further provides a method for accelerating speed of refreshing image frame, for driving a display-panel to display an image frame and refreshing the image frame rapidly.

According to the method, the first step is to generate the image frame according to a digital content, so as to drive the display-panel to display the image frame. Then, it is to continuously receive screen operation commands. And after receiving each screen operation command, the method is to perform the following steps: buffering the screen operation command, and setting a time interval; if another screen operation command is input within the time interval, determining whether another screen operation command is identical to the previous screen operation command; if another screen operation command is identical to the previous screen operation command, repeatedly performing the step of buffering the screen operation command; and if another screen operation command is different from the previous screen operation command, refreshing the image frame according to the identical screen operation commands.

One or more embodiment of this disclosure further provides a display device for rapid refreshing image frame including a display-panel, an operation interface, a memory module and a controller, in which the display-panel is for displaying an image frame. The operation interface is for generating a screen operation command. The controller is for generating the image frame according to a digital content, so as to drive the display-panel to display the image frame; and the controller is also for receiving a screen operation command to set a time interval.

If another screen operation command is input within the time interval and another screen operation command is identical to the previous screen operation command, the controller repeatedly buffers another screen operation command.

If another screen operation is input within the time interval and another screen operation command is not identical to the previous screen operation command, the controller drives the display-panel to refresh the image frame according to the identical screen operation commands.

If no other screen operation commands are input within the time interval, the controller loads the buffered screen operation command and obtains display content according to the screen operation command to drive the display-panel to refresh the image.

Using the display device or performing the method in one or more embodiments of this disclosure, the display-panel rapidly refreshing image frame to respond screen operation commands, and it is not required to wait the display-panel to refresh entire image frame according to all screen operation commands one by one, therefore the operation process of the display device is improved.

### BRIEF DESCRIPTION OF THE DRAWINGS

The present invention will become more fully understood from the detailed description given herein below for illustration only and thus not limitative of the present invention, wherein:

FIG. 1 is a circuit block diagram of a display device applying a method for accelerating speed of refreshing image frame according to a first embodiment;

FIG. 2A and FIG. 2B are schematic views of image frame refresh according to a first embodiment;

FIG. 3A and FIG. 3B are schematic views of image frame refresh according to a second embodiment;

FIG. 4 is a flow chart according to the second embodiment;

FIG. 5A and FIG. 5B are schematic views of image frame refresh according to a third embodiment;

FIG. 6A and FIG. 6B are schematic views of image frame refresh according to a fourth embodiment;

FIG. 7A and FIG. 7B are schematic views of image frame refresh according to a fifth embodiment;

FIG. 8A and FIG. 8B are schematic views of image frame refresh according to a sixth embodiment;

FIG. 9A and FIG. 9B are schematic views of image frame refresh according to a seventh embodiment;

FIG. 10A and FIG. 10B are schematic views of image frame refresh according to an eighth embodiment;

FIG. 11A and FIG. 11B are schematic views of image frame refresh according to a ninth embodiment;

FIG. 12A and FIG. 12B are schematic views of image frame refresh according to a tenth embodiment;

FIG. 13 is a variation of the method flow chart of FIG. 4; and

FIG. 14 is a flow chart of background operation in FIG. 13.

### DETAILED DESCRIPTION

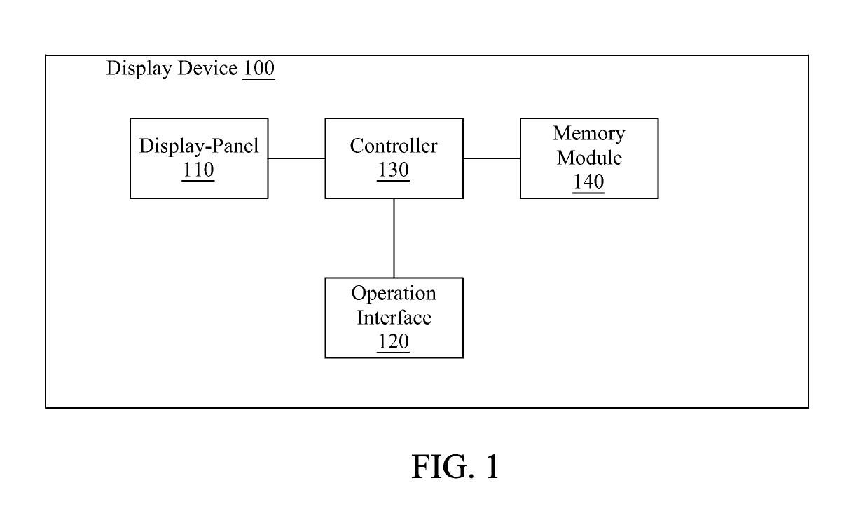

FIG. 1 is a circuit block diagram of a display device 100 for rapid refreshing image frame according to a first embodiment, which is installed with a program code, so as to execute a method for accelerating speed of refreshing image frame. The display device 100 includes a display-panel 110, an operation interface 120, a controller 130, and a memory module 140.

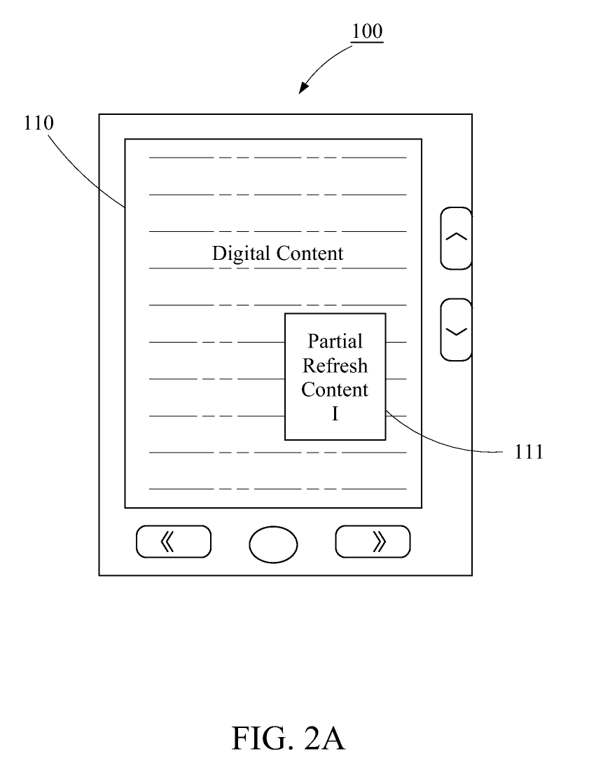

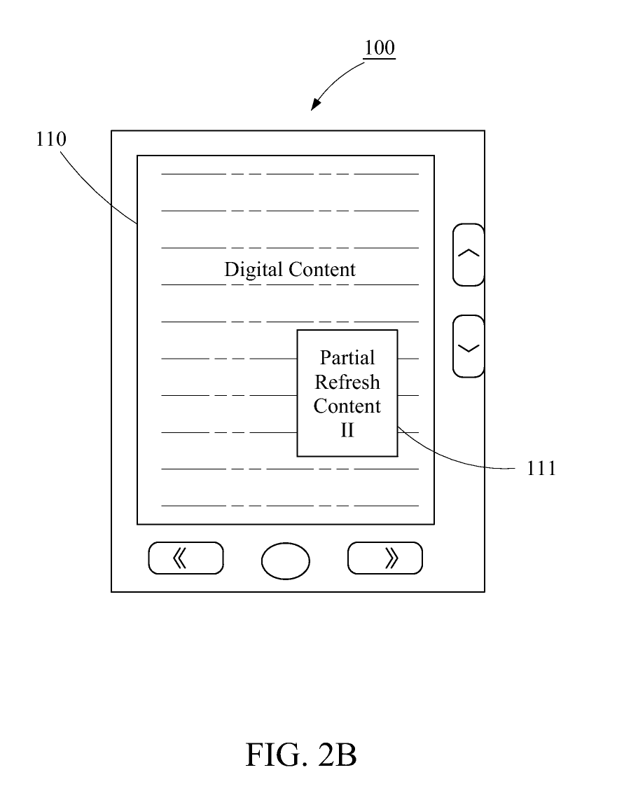

Please refer to FIG. 1, FIG. 2A and FIG. 2B, in which an embodiment of the display-panel 110 is a display-panel with a low image frame refresh speed, for example (but not limited to), an electrophoretic display-panel (electronic paper), or a gray-level liquid crystal display. The method for accelerating speed of refreshing image frame is used for driving the display-panel 110 to display an image frame and refreshing the image frame rapidly.

An example of the operation interface 120 is a key set including a plurality of keys, a multidirectional key, or a touch-control interface, for being operated to generate a screen operation command.

Please refer to FIG. 1, FIG. 2A and FIG. 2B, in which the display-panel 110 and the operation interface 120 are electrically connected to the controller 130. The controller 130 generates the image frame according to a digital content, and drives the display-panel 110 to display the image frame. Meanwhile, the controller 130 defines a partial refresh area 111 in the image frame, so as to display partial refresh content through the partial refresh area 111.

Please refer to FIG. 1, in which the memory module 140 is electrically connected to the controller 130, and used for storing an operating system, an application program, the digital content, etc.

When a partial digital content of the image frame has to be refreshed, the controller 130 defines the partial refresh area 111 in the image frame, clears the original displayed content in the partial refresh area 111 to blank, and then refreshes displayed content in the partial refresh area 111 using the partial refresh content.

At this time, the controller 130 only drives the display-panel 110 to refresh the partial content displayed in the partial refresh area 111 instead of refreshing the entire image frame.

To accelerate the speed of refreshing content displayed in the partial refresh area 111, in the embodiment a rapid control mode is used to drive pixels in the partial refresh area 111. Although the rapid control mode may affect the display performance or reduce the contract of partial display content, this rapid control mode may enable the user to predict a final displayed image frame after inputting the screen operation command, so as to determine whether to stop or continue inputting another screen operation command.

An embodiment of the rapid control mode is reducing the number of gray levels of the partial refresh area 111. For example, the display-panel 110 has gray levels 1 to 32, but the controller 130 only enables the partial refresh area 111 to have the 1st, 8th, 16th, 24th and 32nd levels. That is to say, originally 32 gray levels are utilized in the display-panel 110, but at this time only 5 of the 32 gray levels are utilized in the partial refresh area 111.

For an electrophoretic display, when a large number of gray levels are utilized, the change of the gray level of each pixel must be driven slowly, so as to drive each pixel to display with an accurate gray level value. After the number of gray levels of the partial refresh area 111 is reduced, for example, in the above case that 5 gray levels are utilized, the gray level displayed by each pixel may also have a required value if the change of the gray level of each pixels is driven rapidly. Thus the image displayed in the partial refresh area 111 is refreshed rapidly. Furthermore, for pixels outside the partial refresh area 111, a zero potential (0 V) may be applied, so as to ensure that the originally display does not change.

Therefore, according to the first embodiment, the display device 100 executes the method for accelerating speed of refreshing image frame. According to this method the controller 130 extracts a digital content from the memory module 140 or through other data interfaces, and generates an image frame according to the digital content, so as to drive the display-panel 110 to display the image frame.

Next, the controller 130 defines a partial refresh area 111 on the image frame, so as to drive pixels in the partial refresh area 111 in the rapid control mode, thereby accelerating refresh of the partial content displayed in the partial refresh area 111, as shown in FIG. 2A. As described previously, an example of the rapid control mode is reducing the number of gray levels of the partial refresh area 111.

After receiving an screen operation command, the controller 130 extracts corresponding partial refresh content from the digital content stored in the memory module 140 according to the screen operation command, and refreshes partial content displayed in the partial refresh area 111, as shown in FIG. 2B.

The digital content may be an ordinary text or picture, and the partial refresh content displayed by the partial content displayed in the partial refresh area 111 may be a text note. Through this method, the partial content displayed of the text note is refreshed rapidly, so as to enable the user to find the desired note content rapidly.

The screen operation command may be input through the operation interface 120, or received externally through other interfaces. For example, when the display device 100 is connected to a network and obtains the digital content through the network, the display device 100 may execute the screen operation command received from the network to obtain the partial refresh content, so as to refresh the displayed content of the partial refresh area 111.

In the aforementioned embodiment, the display device 100 rapidly refresh the partial image frame in the partial refresh area 111 to respond the screen operation command input by the user. Therefore the user can realize that the display device 100 has received the screen operation command and the number of the screen operation commands received by the display device 100, so as to prevent the user from felling that the display device 100 is slow in responding the screen operation commands.

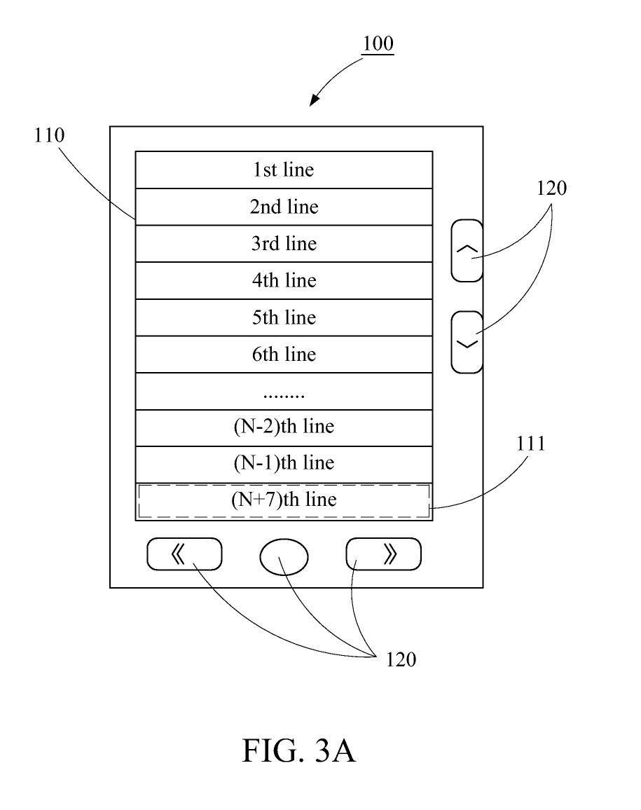

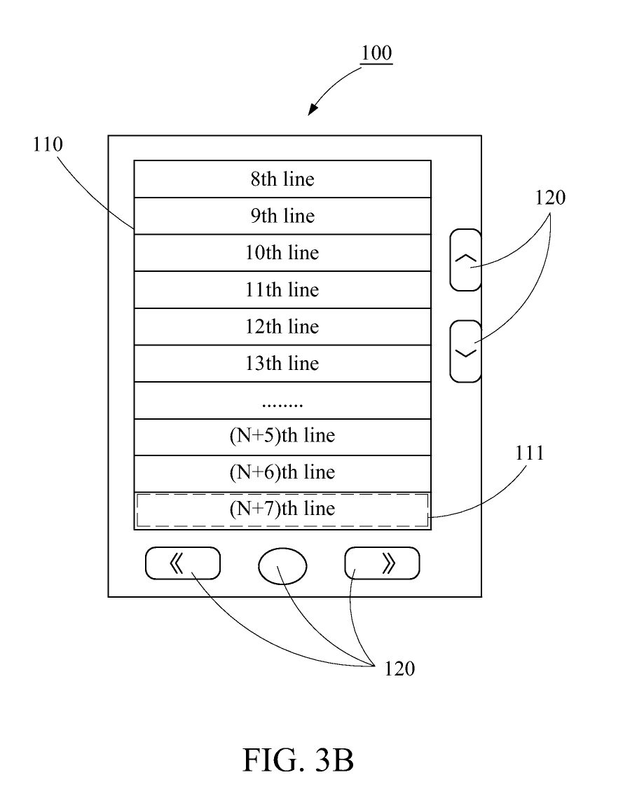

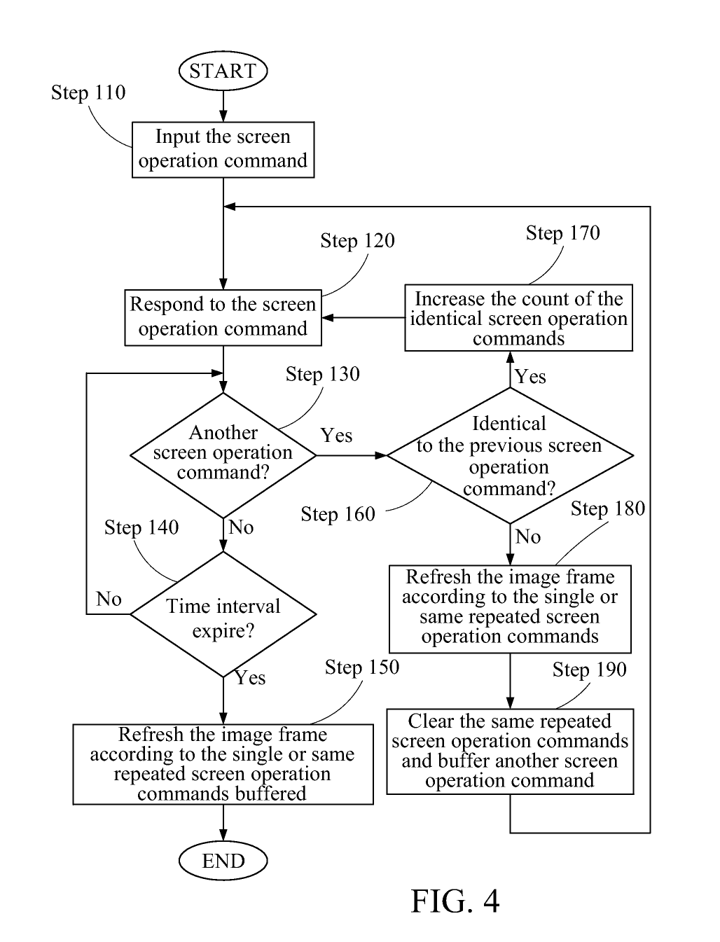

FIG. 3A, FIG. 3B and FIG. 4 illustrate a method for accelerating speed of refreshing image frame according to a second embodiment, which is described in detail below.

Please refer to FIG. 3A, FIG. 3B and FIG. 4, after the display device 100 is turned on by the user and the user starts to operate the display device 100, the controller 130 of the display device 100 generates an image frame according to a digital content, and drives the display-panel 110 to display the image frame. In this embodiment, the digital content is a multi-line text. Each screen operation command corresponds to a scroll direction and a scroll distance. The scroll direction is for scrolling the displayed content upwards or downwards, and the scroll distance is for scrolling by one line each time.

Next, the controller 130 waits for the user to input the screen operation command through the operation interface 120, as shown in Step 110.

After receiving the screen operation command, the controller 130 generates a response command to perform a response process for responding to the screen operation command, and buffers the screen operation command, as shown in Step 120. In one or more embodiments, the screen operation command is buffered in a register of the controller 130, or buffered in the memory module 140.

To perform the response process for responding to the screen operation command, a partial refresh area 111 is defined in a part of the image frame, for example, the bottommost part of the image frame to accommodate one line of text is defined as the partial refresh area 111, as shown in FIG. 3A.

After receiving each screen operation command, the controller 130 generates a response command, so that the display-panel 110 refreshes the partial refresh area 111 according to the response command to display the next line of text. As shown in FIG. 3A, if seven screen operation commands of scrolling upwards are continuously received, the display content of the partial refresh area 111 is refreshed from the N-th line to the (N+7)th line of text. Likewise, the rapid control mode is carried out in the partial refresh area 111 to refresh the N-th line of text to the (N+7)th line, for example, reducing the number of gray levels of the partial refresh area 111, so as to refresh rapidly the image display of the partial refresh area 111. Therefore the user can realize that the display device 100 has received the screen operation command and the number of the screen operation commands received by the display device 100, so as to prevent the user from felling that the display device 100 is slow in responding the screen operation commands.

The controller 130 sets a time interval. After receiving each screen operation command (as shown in Step 120), the controller 130 starts timing, and determines whether the controller 130 receives another screen operation command within the time interval, as shown in Step 130 and Step 140.

The process loop executed by the controller 130 is as described below. The controller 130 determines whether another screen operation command is received at first, as shown in Step 130. If another screen operation command is not input, the controller 130 determines whether the time interval expires, as shown in Step 140, and if the controller 130 determines that the time interval expires, it is determined that no other screen operation commands are input to the controller 130 within the time interval through the operation interface 120.

If the controller 130 determines that the time interval does not expire in Step 140, the controller 130 returns to Step 130 and determines again whether another screen operation command is input.

If the controller 130 determines that another screen operation command is input, the controller 130 further determines whether another screen operation command is identical to the previous screen operation command, as shown in Step 160.

If another screen operation command is identical to the previous screen operation command, for example, the screen operation command is still an screen operation command of scrolling upwards as shown in this embodiment, the controller 130 buffers the screen operation command, so as to increase the count of the identical screen operation commands, as shown in Step 170. Afterwards, the controller 130 generates a response command for responding to the screen operation command, as shown in Step 120.

If another screen operation command is different from the previous screen operation command, and is different from the previous screen operation command of scrolling upwards, for example, an screen operation command of scrolling downwards, the controller 130 refreshes the image frame according to the single or same repeated screen operation commands, as shown in Step 180. Afterwards, the controller 130 clears the same repeated screen operation commands, and returns to Step 120, so as to buffer another screen operation command and reset the time value of the timing mechanism, as shown in Step 190.

If no other screen operation commands are input after Step 130 and Step 140, the controller 130 refreshes the image frame according to the single or same repeated screen operation commands buffered, and clears the buffered screen operation commands, as shown in Step 150. In this embodiment, the variation of the display range is scrolling downwards by seven lines, and the controller 130 finds the corresponding part to be displayed after the image is scrolled downwards by seven lines according to the digital content so as to refresh the image, and clears the buffered screen operation commands.

In a specific embodiment, as shown in FIG. 3A and FIG. 3B, the memory module 140 already continuously buffers seven screen operation commands of scrolling upwards by one line, and partially refreshes the content originally displayed by the partial refresh area 111 from the N-th line to the (N+7)th line for responding to the screen operation commands, as shown in FIG. 3A. After the seven screen operation commands of scrolling upwards by one line are received, if no new screen operation command is input to the controller 130 within the time interval, the controller 130 scrolls upwards image frame to refresh the image frame by seven lines according to the seven screen operation commands of scrolling upwards by one line. That is, the controller 130 finds the corresponding part in the digital content according to scrolling upwards image frame by seven lines, and drives the display-panel 110 to refresh the image frame, as shown in FIG. 3B. When refreshing the image frame, the controller 130 clears the screen operation commands that have been executed, and simultaneously resets the response content.

In contrast with the case in which the entire image frame is refreshed immediately each time a screen operation command is received, in the embodiments of this disclosure the entire image frame is refreshed once using the content to be finally displayed after a plurality of screen operation commands is accumulated at one time.

Taking the above specific embodiment as an example, if an image frame refresh method in the prior art is adopted, image frame refresh has to be continuously performed seven times, the time taken for completing the image frame refresh is a total of seven times the refresh of the entire image frame, and each image frame refresh cannot respond rapidly to each screen operation command input by the user, causing the user to believe the response of the display device 100 is too slow to operate.

In contrast, after receiving plural screen operation command, by performing the method according to one or more embodiments of this disclosure, the display device 100 only performs image frame refresh once, which takes time that is 1/7 of that taken in the prior art, thereby accelerating the speed of image frame refresh. In the refreshing process, the display device 100 only prompts the user using the partial refresh area 111, which enables the user to predict whether a refreshed image frame to be displayed is desired. By adopting the mode of reducing the number of gray levels for refreshing, the partial refresh area 111 has a high refresh speed, and can respond rapidly to each screen operation command input by the user, thereby improving user-machine interaction.

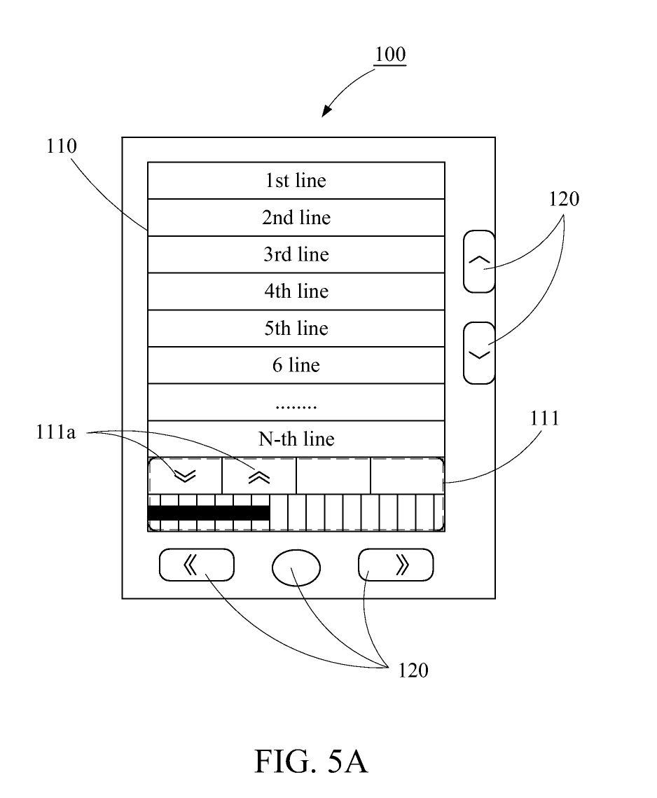

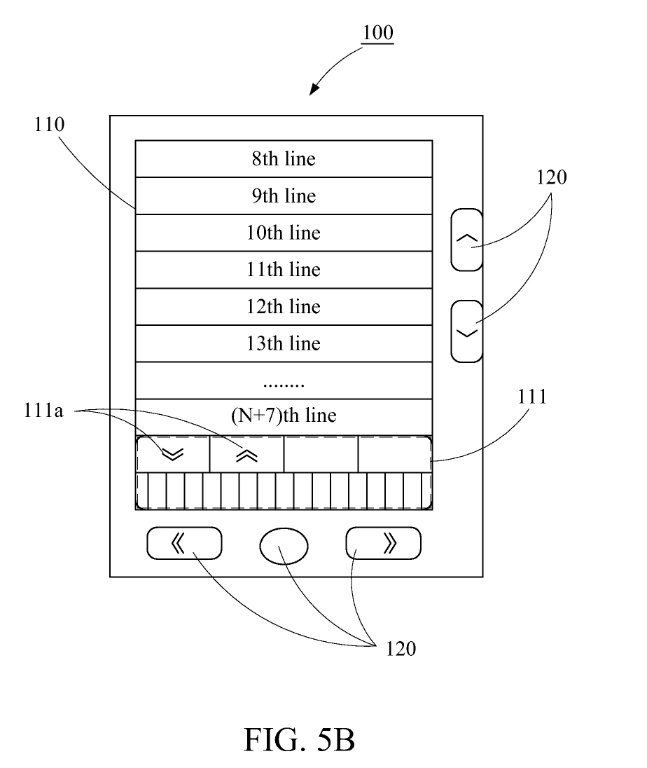

FIG. 5A and FIG. 5B illustrates a method for accelerating speed of refreshing image frame according to a third embodiment. The third embodiment is approximately identical to the second embodiment, and the difference between the two will be described below.

In the third embodiment, each screen operation command corresponds to a scroll direction and a scroll distance. The scroll direction and the scroll distance are respectively scrolling the displayed content upwards or downwards, and scrolling by one line each time.

The step for performing response process according to the screen operation command is not only by refreshing the partial refresh area 111 and displaying in the form of a text or picture, but also by issuing a light signal, generating a prompt sound or generating a speech-voice prompt according to the response command. The aforementioned steps can help the user to realize that the display device has received the input screen operation command and the number of the received screen operation commands; therefore the user will not feel that the display device 100 is slow in response.

As shown in FIG. 5A, after receiving each screen operation command, the controller 130 generates a response command so that the display-panel 110 refreshes the partial refresh area 111, and display length variation of a long bar in the partial refresh area 111 for responding to the number of times for which the input screen operation command is received. The controller 130 drives pixels in the partial refresh area 111 to refresh partial image frame, and at the same time reduces the number of gray levels of the partial refresh area 111, so as to refresh rapidly the displayed content in the partial refresh area 111.

In the specific embodiment shown in FIG. 5A, the controller 130 continuously receives seven screen operation commands of scrolling upwards by one line, and displays a long bar occupying 7 blank spaces in the partial refresh area 111 in response. After the seven screen operation commands of scrolling upwards by one line are received, if no new screen operation command is input to the controller 130 within the time interval, the controller 130 scrolls the displayed content upwards to refresh image frame by seven lines according to the seven screen operation commands of scrolling upwards by one line. That is, the controller 130 finds the corresponding part in the digital content according to scrolling upwards image frame by seven lines, and drives the display-panel 110 to refresh the image frame, as shown in FIG. 5B.

Furthermore, in FIG. 5A and FIG. 5B, the partial refresh area 111 further displays an indication symbol 111a, for indicating that the function currently being executed is scrolling the displayed content upwards or downwards.

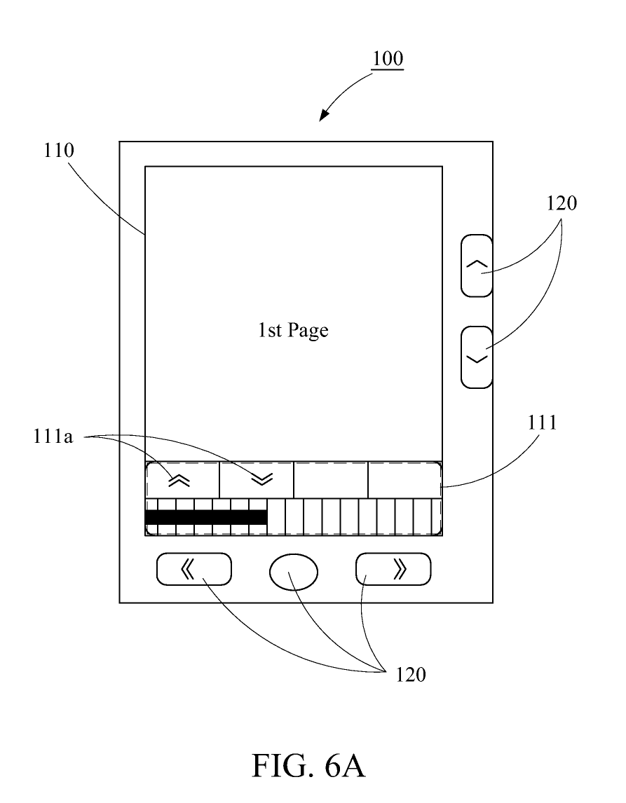

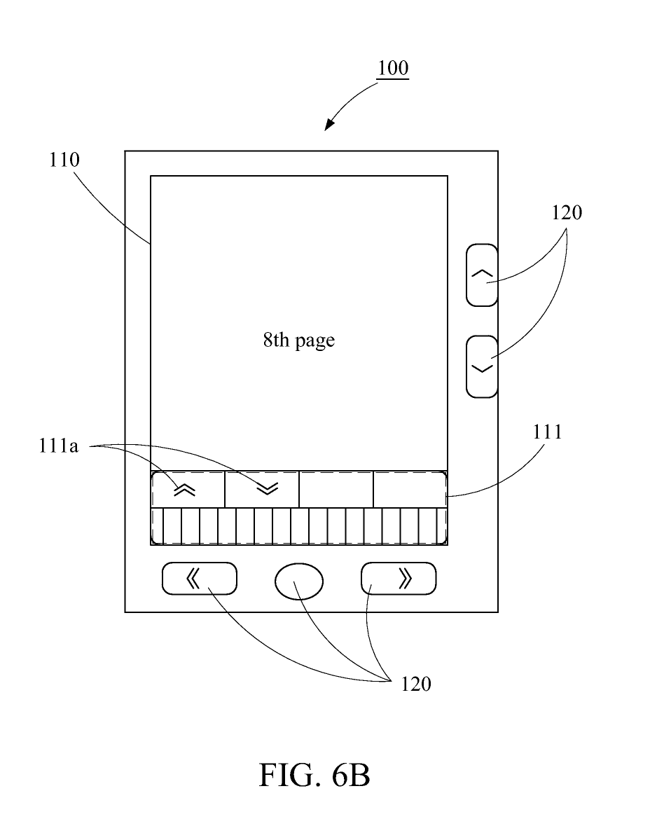

FIG. 6A and FIG. 6B illustrate a method for accelerating speed of refreshing image frame according to a fourth embodiment. The fourth embodiment is approximately identical to the third embodiment, and the difference between the two will be described below.

In the fourth embodiment, each screen operation command corresponds to a scroll direction and a scroll distance. The scroll direction and the scroll distance are respectively scrolling the displayed content upwards or downwards, and scrolling by one page each time.

In the specific embodiment shown in FIG. 6A, the controller 130 continuously receives seven screen operation commands of scrolling upwards by one page, and displays a long bar occupying 7 blank spaces in the partial refresh area 111 in response. After the seven screen operation commands of scrolling upwards by one page are received, if no new screen operation command is transmitted to the controller 130 within the time interval, the controller 130 scrolls the displayed content upwards to refresh image frame 7 pages according to the seven screen operation commands of scrolling upwards by one page. That is, the controller 130 finds the eighth page in the digital content, and drives the display-panel 110 to refresh the image frame, as shown in FIG. 6B.

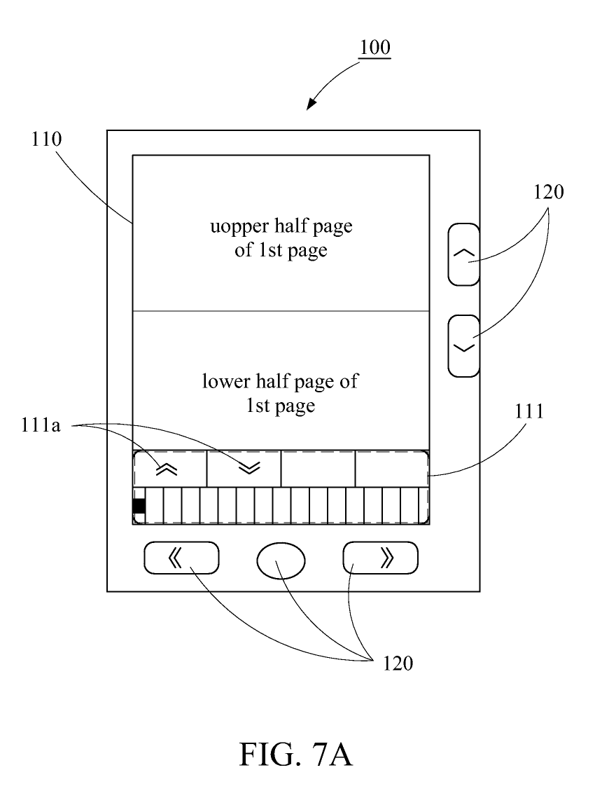

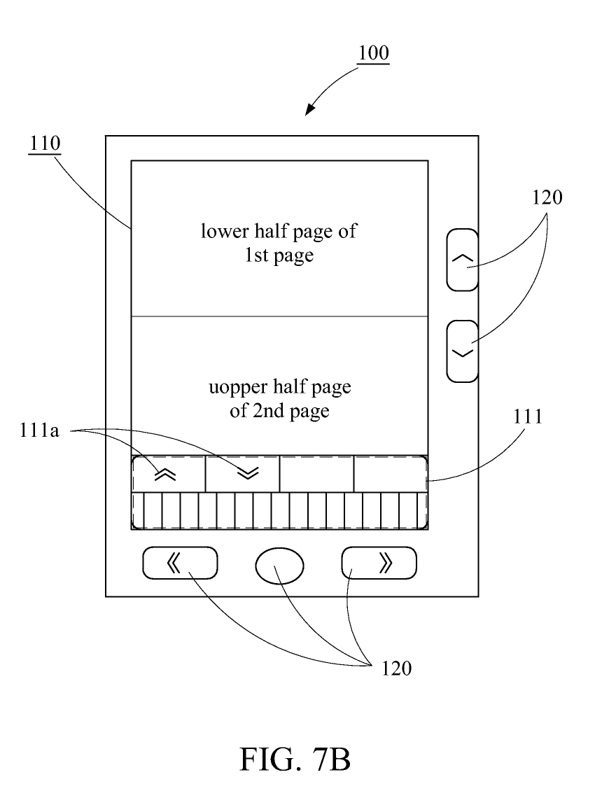

FIG. 7A and FIG. 7B illustrate a method for accelerating speed of refreshing image frame according to a fifth embodiment. The fifth embodiment is approximately identical to the third embodiment, and the difference between the two will be described below.

In the fifth embodiment, each screen operation command corresponds to a scroll direction and a scroll distance. The scroll direction and the scroll distance are respectively scrolling the displayed content upwards or downwards, and scrolling by a half page each time.

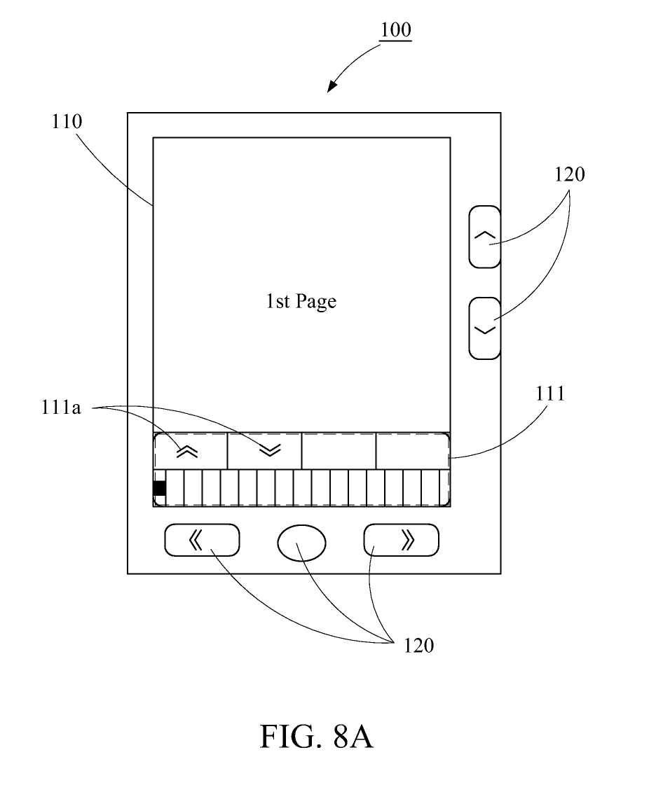

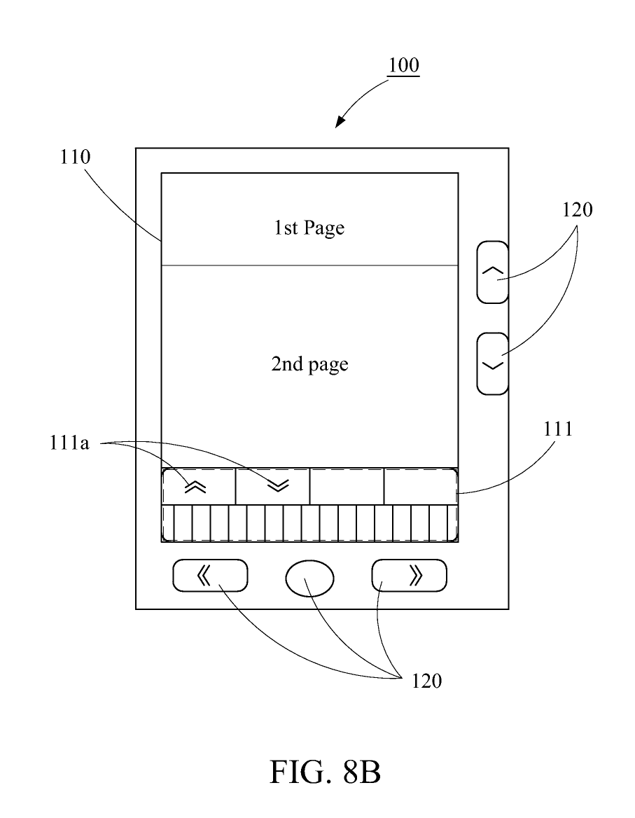

FIG. 8A and FIG. 8B illustrate a method for accelerating speed of refreshing image frame according to a sixth embodiment. The sixth embodiment is approximately identical to the third embodiment, and the difference between the two will be described below.

In the sixth embodiment, each screen operation command corresponds to a scroll direction and a scroll distance. The scroll direction and the scroll distance are respectively scrolling the displayed content upwards or downwards, and scrolling by a designated number of lines of text each time.

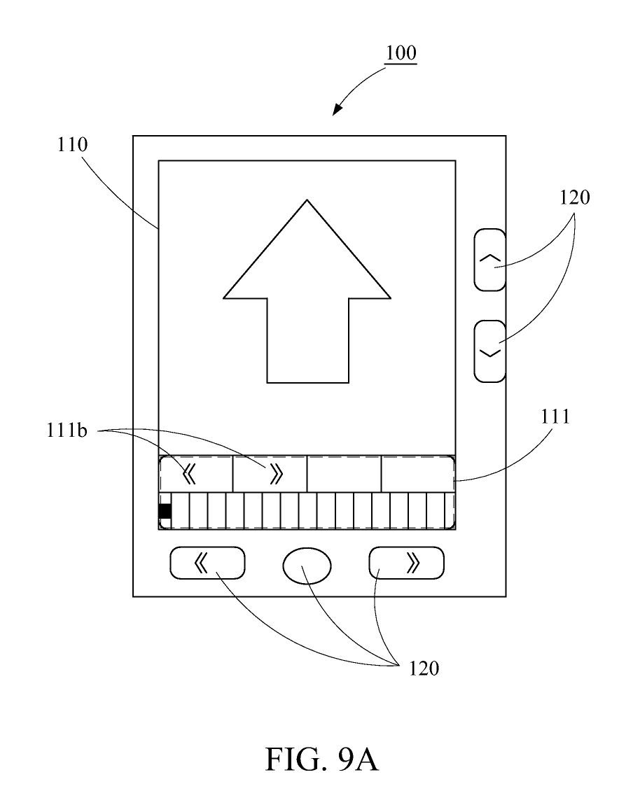

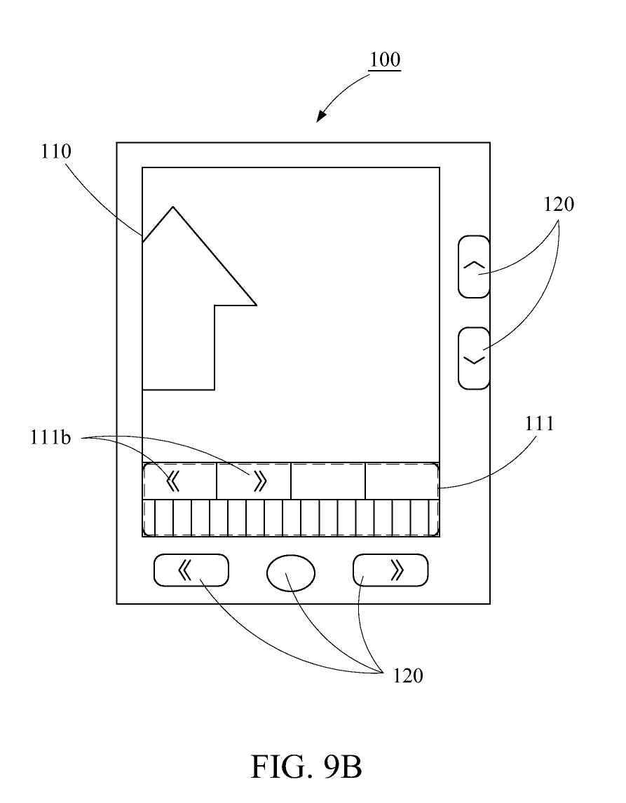

FIG. 9A and FIG. 9B illustrate a method for accelerating speed of refreshing image frame according to a seventh embodiment. The seventh embodiment is approximately identical to the third embodiment, and the difference between the two will be described below.

In the seventh embodiment, each screen operation command corresponds to a scroll direction and a scroll distance. The scroll direction and the scroll distance are respectively translating the image leftwards or rightwards, and translating the image by a designated number of pixels each time.

Furthermore, in FIG. 9A and FIG. 9B, the partial refresh area 111 further displays an indication symbol 111b, for indicating that the function currently being executed is translating the image leftwards or rightwards.

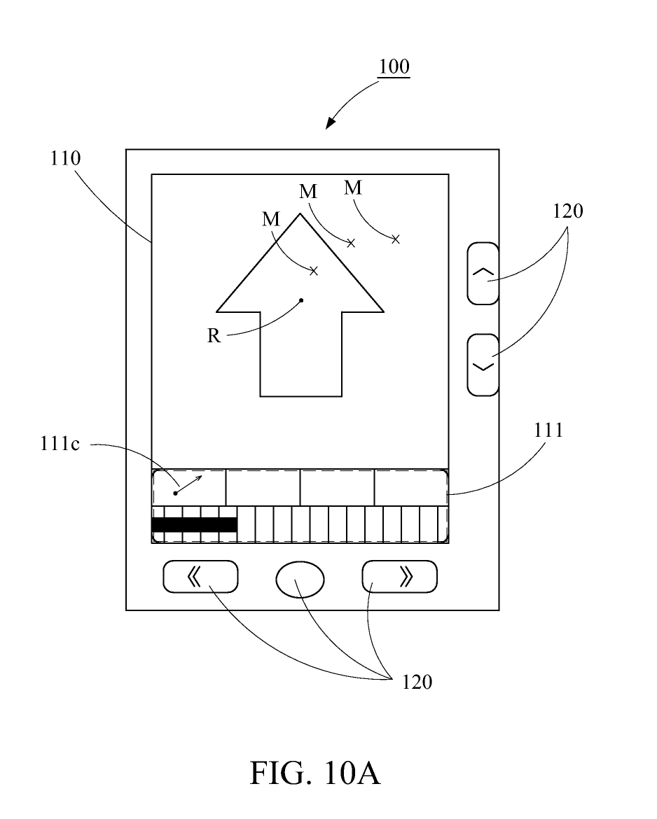

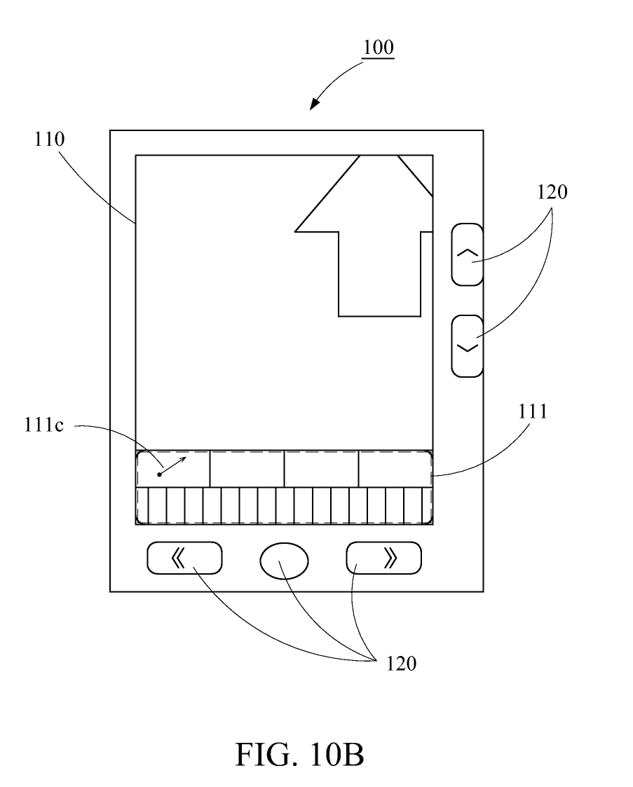

FIG. 10A and FIG. 10B illustrate a method for accelerating speed of refreshing image frame according to an eighth embodiment of the present invention. The eighth embodiment is approximately identical to the seventh embodiment, and the difference between the two will be described below.

In the eighth embodiment, each screen operation command corresponds to a scroll direction and a scroll distance. In a method for determining the scroll direction and the scroll distance, a reference point R is determined in the image first, and then a displacement point M is determined to serve as a screen operation command. The direction and the distance of translation of the image each time can be determined according to the reference point R and the displacement point M.

Furthermore, in FIG. 10A and FIG. 10B, the partial refresh area 111 further displays an indication symbol 111c, for indicating that the function currently being executed is translating the image in any direction.

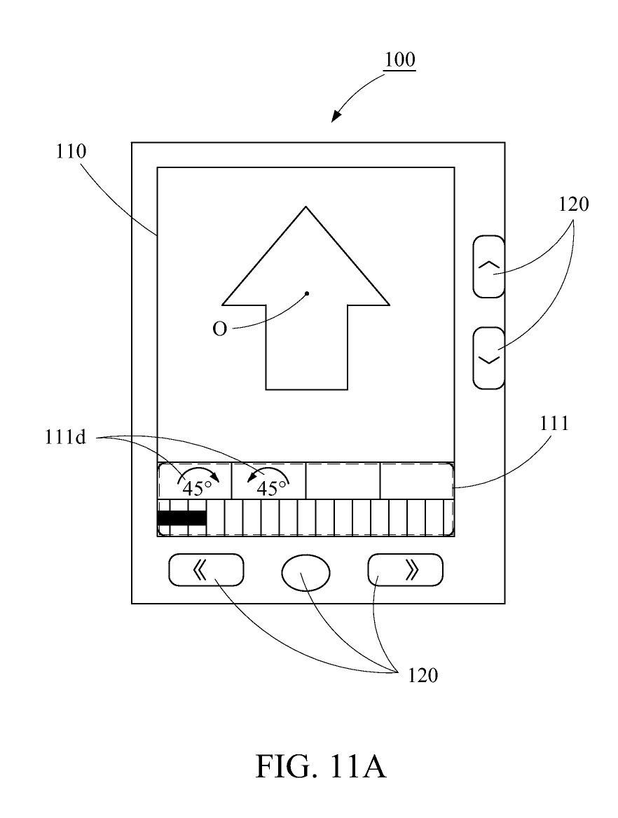

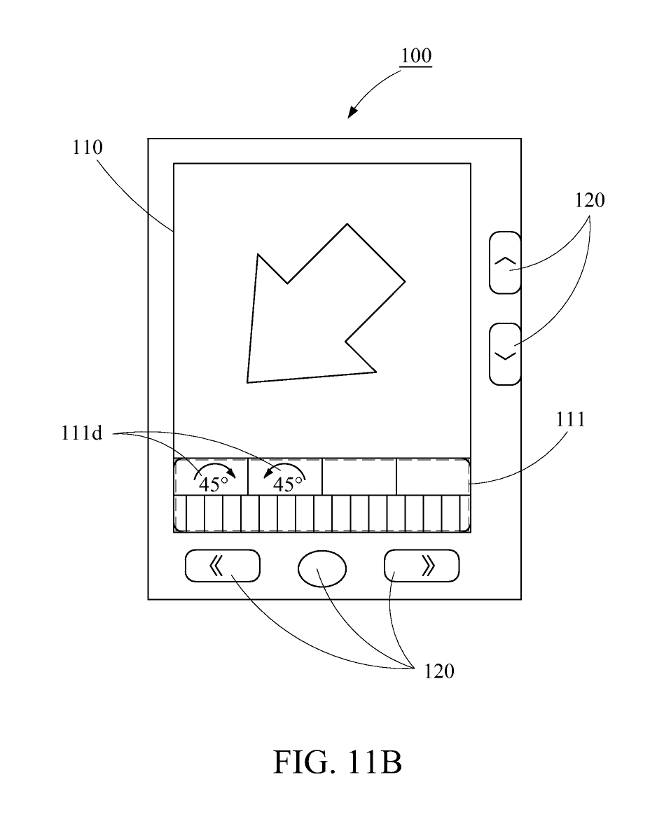

FIG. 11A and FIG. 11B illustrate a method for accelerating speed of refreshing image frame according to a ninth embodiment of the present invention. The ninth embodiment is approximately identical to the third embodiment, and the difference between the two will be described below.

In the ninth embodiment, each screen operation command corresponds to a scroll direction and a scroll distance. The scroll direction and the scroll distance are respectively rotating the image frame according to a center point clockwise or anticlockwise, and rotating the image by a designated angle (for example, 45° or 90°) each time.

Furthermore, in FIG. 11A and FIG. 11B, the partial refresh area 111 further displays an indication symbol 111d, for indicating that the function currently being executed is rotating the image by a designated angle.

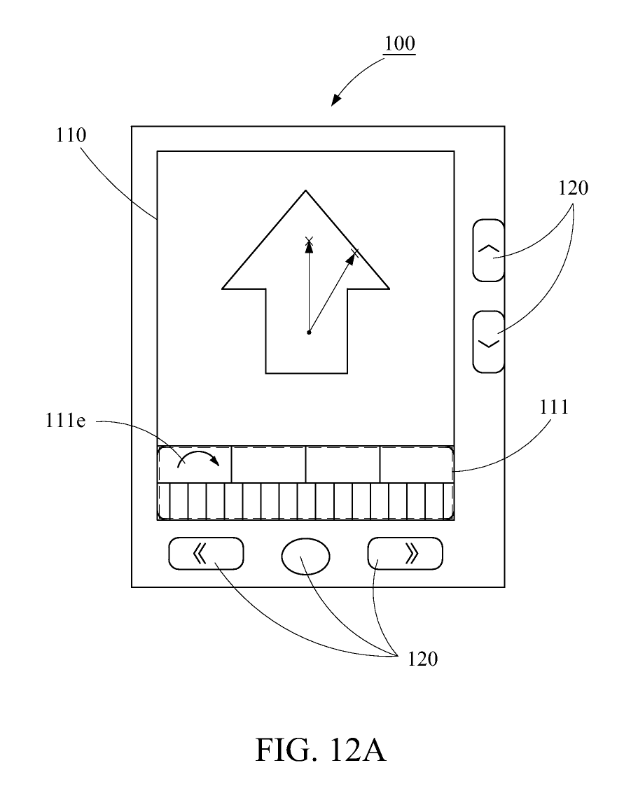

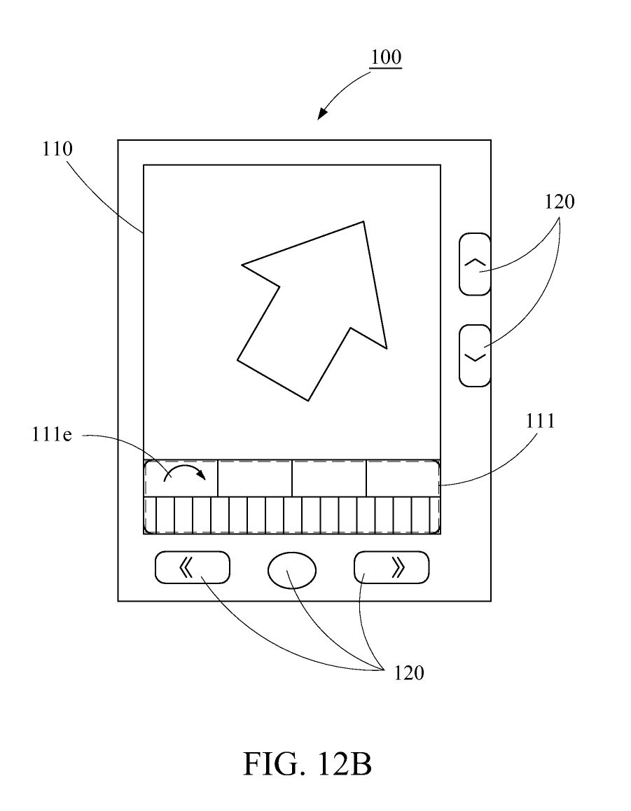

FIG. 12A and FIG. 12B illustrate a method for accelerating speed of refreshing image frame according to a tenth embodiment of the present invention. The tenth embodiment is approximately identical to the ninth embodiment, and the difference between the two will be described below.

In the tenth embodiment, each screen operation command corresponds to a scroll direction and a scroll distance. In a method for determining the scroll direction and the scroll distance, a center point O is determined in the image, and then a starting point S is determined, so as to generate a reference axis. An end point is then determined to serve as a screen operation command, and the direction and the angle of rotation of the image each time can be determined according to an angle included between a line connecting the end point E to the center point O and the reference axis.

Furthermore, in FIG. 12A and FIG. 12B, the partial refresh area 111 further displays an indication symbol 111e, for indicating that the function currently being executed is rotating the image by any angle.

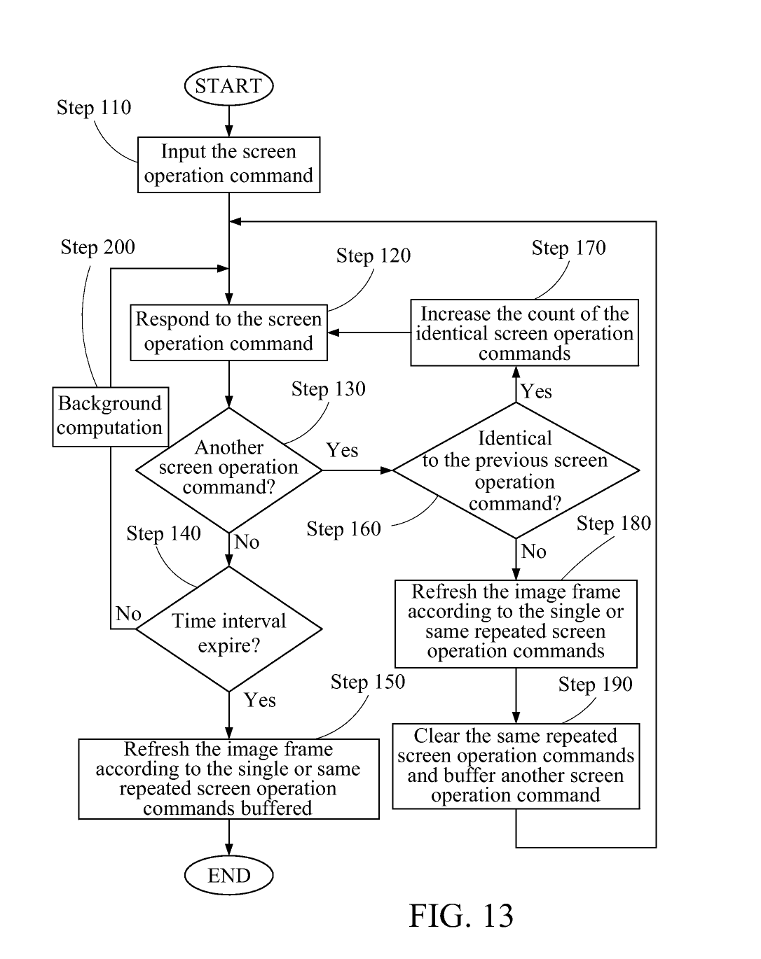

FIG. 13 is a variation of the method flow chart of FIG. 4.

Before Step 140 in which the controller 130 determines that the time interval does not expire and returns to Step 130, the controller 130 executes a background computation in a time division or multi-threaded manner (Step 200), so as to generate a corresponding image frame through computation according to the repeated screen operation commands buffered and to buffer the image frame, thereby reducing the time required for subsequent computations.

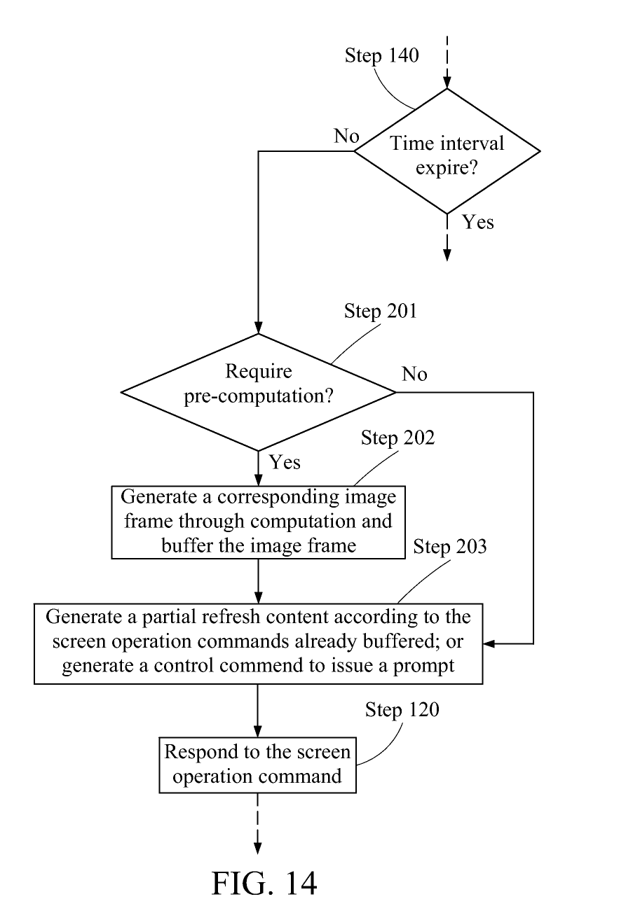

As shown in FIG. 14, during the background computation, the controller 130 first determines whether the memory module 140 buffers a screen operation command requiring pre-computation, as shown in Step 201. The screen operation command requiring pre-computation is mainly one for panning the image frame by a fixed scroll distance each time, for example, scrolling upwards/downwards by one page, or scrolling upwards/downwards by one or more lines. If the screen operation command requiring pre-computation exists, the controller 130 extracts the corresponding digital content according to the screen operation commands, generates a corresponding image frame through computation, and buffers the image frame in the memory module 140, as shown in Step 202. Then, according to the screen operation commands already buffered in the memory module 140, the controller 130 generates a partial refresh content of the partial refresh area 111; alternatively, according to the response command generated by the controller 130, the controller 130 generates a control commend to issue a prompt such as light signal, a prompt sound or a prompt voice for responding to the screen operation commands, as shown in Step 203.

Finally, the process executed by the controller 130 returns to Step 130, and the result obtained in Step 203 is used for responding to the input screen operation command.

In Step 201, if no screen operation command requiring pre-computation exits, the controller 130 directly executes Step 203, and returns to Step 130.

In the embodiments of this disclosure, after receiving the screen operation commands, the display device 100 does not refresh the entire image frame for each screen operation command. According to one or more embodiments in this disclosure, the display device 100 directly refreshes with the desired final image when no other repeated screen operation commands are received within a time interval; therefore, the display device 100 does not need to wait for the display-panel 110 to refresh the image frame according to the screen operation commands one by one, and instead, the display device 100 refreshes the image frame once in response to a plurality of continuously input image scrolling commands, which achieves a high image refresh speed. Meanwhile, as the partial refresh area 111 with a small number of gray levels is refreshed rapidly for responding to the user, excellent user-machine interaction is established, thereby preventing the user from feeling the low response speed of the display device 100 and improve the operation of the display device 100.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention is included in the appended claims of the present invention.

What is claimed is:

1. A method for accelerating speed of refreshing image frame, for driving a display-panel to display an image frame and refreshing the image frame rapidly, comprising:
generating the image frame according to a digital content, so as to drive the display-panel to display the image frame;
defining a partial refresh area on the image frame; and
receiving at least one screen operation command, extracting partial refresh content from the digital content according to the screen operation command, and refreshing displayed content in the partial refresh area.

2. The method for accelerating speed of refreshing image frame as claimed in claim 1, further comprising a step of:
reducing a number of gray levels of the partial refresh area.

3. A method for accelerating speed of refreshing image frame, for driving a display-panel to display an image frame and refreshing the image frame rapidly, comprising:
generating the image frame according to a digital content, so as to drive the display-panel to display the image frame;
receiving screen operation commands, and performing the following steps after receiving each screen operation command:
buffering the screen operation command;
setting a time interval;
if another screen operation command is input within the time interval, determining whether another screen operation command is identical to the previous screen operation command;
if another screen operation command is identical to the previous screen operation command, repeatedly performing the step of buffering the screen operation command; and
if another screen operation command is different from the previous screen operation command, refreshing the image frame according to the identical screen operation commands.

4. The method for accelerating speed of refreshing image frame as claimed in claim 3, wherein after the step of refreshing the image frame according to the identical screen operation commands, the method further comprises the steps of:
clearing the identical screen operation commands; and
buffering another screen operation command.

5. The method for accelerating speed of refreshing image frame as claimed in claim 3, wherein:
if no other screen operation commands are input within the time interval, loading the buffered screen operation command, and obtaining a display content according to the screen operation command to refresh the image.

6. The method for accelerating speed of refreshing image frame as claimed in claim 5, further comprising the step of:
generating a response command after receiving each screen operation command, so as to perform a response process.

7. The method for accelerating speed of refreshing image frame as claimed in claim 6, wherein the response process comprising the steps of:
defining a partial refresh area on the image frame; and
refreshing the partial refresh area according to the response command for responding to the screen operation command.

8. The method for accelerating speed of refreshing image frame as claimed in claim 7, wherein:
if another screen operation command is identical to the previous screen operation command, repeatedly performing the step of refreshing the displayed content of the partial refresh area.

9. The method for accelerating speed of refreshing image frame as claimed in claim 7, further comprising:
reducing a number of gray levels of the partial refresh area.

10. The method for accelerating speed of refreshing image frame as claimed in claim 7, wherein after the step of refreshing the image frame according to the identical screen operation commands, the method further comprises:
clearing the buffered identical screen operation commands; and
refreshing the partial refresh area for responding to another screen operation command, and buffering the screen operation command.

11. The method for accelerating speed of refreshing image frame as claimed in claim 6, wherein the response process is selected from the groups consisting of generating a light signal, generating a speech-voice prompt, and generating a sound prompt.

12. The method for accelerating speed of refreshing image frame as claimed in claim 6, wherein each screen operation command corresponds to a scroll direction and a scroll distance of the image frame.

13. The method for accelerating speed of refreshing image frame as claimed in claim 12, wherein the scroll direction is scrolling the displayed content upwards or downwards.

14. The method for accelerating speed of refreshing image frame as claimed in claim 13, wherein the scroll distance is scrolling by one line of text, scrolling by a plurality of lines of text, or scrolling by one page.

15. The method for accelerating speed of refreshing image frame as claimed in claim 12, wherein
the scroll direction is translating the image leftwards or rightwards; and
the scroll distance is translating the image by a designated number of pixels.

16. The method for accelerating speed of refreshing image frame as claimed in claim 12, wherein
the scroll direction is rotating the image frame according to a center point clockwise or anticlockwise; and
the scroll distance is rotating the image by a designated angle.

17. A display device for rapid refreshing image frame, comprising:
a display-panel, for displaying an image frame;
an operation interface, for generating a screen operation command;
a controller, for generating the image frame according to a digital content, so as to drive the display-panel to display the image frame; and for receiving a screen operation command to set a time interval;
wherein if another screen operation command is input within the time interval and another screen operation command is identical to the previous screen operation command, the controller repeatedly buffers another screen operation command;
wherein if another screen operation is input within the time interval and another screen operation command is not identical to the previous screen operation command, the controller drives the display-panel to refresh the image frame according to the identical screen operation commands; and
wherein if no other screen operation commands are input within the time interval, the controller loads the buffered screen operation command and obtains a display content according to the screen operation command to drive the display-panel to refresh the image.

18. The display device as claimed in claim 17, wherein after the controller drives the display-panel to refresh the image frame, the controller cleans the identical screen operation commands and buffers another screen operation command.

19. The display device as claimed in claim 18, wherein after the controller receives each of the screen operation commands, the controller defines a partial refresh area on the image frame define, and drives the display-panel to refresh the partial refresh area to respond the screen operation command.

20. The display device as claimed in claim 18, wherein after the controller receives each of the screen operation commands, the controller responds the screen operation command by generating a light signal, generating a speech-voice prompt, and generating a sound prompt.
